(19) United States
(12) Patent Application Publication
(10) Pub. No.: US 2007/0232516 A1
(43) Pub. Date: Oct. 4, 2007

(54) Formulation of aliphatic fatty alcohols into foaming detergent compositions for maintaining textiles or hard surfaces

(75) Inventors: Olivier Anthony, Meriel (FR); Evelyne Prat, Pantin (FR)

Correspondence Address: BUCHANAN, INGERSOLL & ROONEY PC, POST OFFICE BOX 1404, ALEXANDRIA, VA, 22313-1404, US

(73) Assignee: RHODIA CHIMIE, AUBERVILLIERS (FR)

(21) Appl. No.: 11/727,845

(22) Filed: Mar. 28, 2007

Related U.S. Application Data
(63) Continuation of application No. PCT/FR05/02385, filed on Sep. 27, 2005.

(30) Foreign Application Priority Data
Sep. 29, 2004 (FR) 0410303

(51) Int. Cl. C11D 17/08

(52) U.S. Cl. 510/421

(57) ABSTRACT

Detergent composition that generate foams in aqueous media, which foams have improved rheology and appearance (whiteness), contain at least one surfactant (S) selected from the group consisting of anionic and nonionic surfactants and mixtures thereof, and at least one C₈-C₂₂ aliphatic alcohol (AA).

### CROSS-REFERENCE TO PRIORITY/PCT APPLICATIONS

This application claims priority under 35 U.S.C. § 119 of FR 04/10303, filed Sep. 29, 2004, and is a continuation of PCT/FR 2005/002385, filed Sep. 27, 2005 and designating the United States, published in the French language on Apr. 6, 2006 as WO 2006/035154 A1; (the title and abstract were also published in English), each hereby expressly incorporated by reference in its entirety and each assigned to the assignee hereof.

### BACKGROUND OF THE INVENTION

1. Technical Field of the Invention

The present invention relates to the formulation, into foaming detergent compositions for maintaining textiles or hard surfaces, of aliphatic fatty alcohols; the presence of an aliphatic fatty alcohol makes it possible to improve the appearance of the foam formed under the usual conditions of use of said compositions.

2. Description of Background and/or Related and/or Prior Art

It is known practice to produce stable foams from a concentrated aqueous composition comprising a foaming anionic surfactant (optionally ethoxylated fatty alcohol sulfates, fatty alcohol sarcosinates, alkanolamide sulfosuccinates, long-chain α-olefin sulfonates, long-chain alkylbenzenesulfonates), a C₁₂-C₁₆ alkanol, optionally a solvent (isopropyl alcohol, butoxyethanol, etc.) and optionally a polymer (polyacrylic acids, ethylene oxide-propylene oxide block copolymers, polyethylene glycols, biopolymers). The stable foams obtained have a multitude of uses, namely, as a soil marker for agricultural surfaces during a plant-protection treatment, as an insulator in safety systems, in drilling fluids, and as an aid for the extinction of forest fires in particular (U.S. Pat. Nos. 4,050,944; 4,442,018, 4,770,794; 6,369,122; 6,376,566).

The consumer, during cleaning or maintenance operations which he performs or which are performed in his presence, using a foaming detergent composition, is acutely sensitive to the abundance and appearance of the foam formed and in particular to its opacity or whiteness, which are indications of performance of the detergent medium.

### SUMMARY OF THE INVENTION

The present invention provides stable foams of improved appearance, under the normal conditions of use of a detergent formulation for maintaining surfaces, especially for cleaning hard household or institutional surfaces or textiles, for washing kitchenware by hand, for washing laundry by hand or in a semiautomatic machine or for washing motor vehicle bodywork.

More especially, this invention provides foams of better esthetic appearance, especially as regards their whiteness, and also a creamy appearance.

These benefits are reflected, from the point of view of the consumer, by an impression of cleanliness, and also of care for the treated surface. When it is a matter of washing by hand, this impression is also perceived on the manipulator's hands.

The present invention features the formulation, into detergent compositions capable of foaming in aqueous media, based on at least one surfactant (S) selected from among anionic surfactants and nonionic surfactants, or mixtures thereof, for cleaning or maintaining textiles or hard surfaces, of at least one C₈-C₂₂, preferably C₁₂-C₁₈ and most preferentially C₁₂-C₁₆ aliphatic alcohols (AA).

### DETAILED DESCRIPTION OF BEST MODE AND SPECIFIC/PREFERRED EMBODIMENTS OF THE INVENTION

More particularly, the subject aliphatic alcohols are formulated into detergent compositions for cleaning or maintaining hard surfaces or textiles, especially in compositions for cleaning or maintaining hard household or institutional surfaces or textiles, in particular for maintaining toilet bowls, for maintaining bathroom or kitchen surfaces, for washing kitchenware by hand, for washing laundry by hand or in a semiautomatic machine, or for cleaning or maintaining motor vehicle bodywork.

The subject detergent compositions may be in any form, especially in aqueous or non-aqueous liquid form, preferably concentrated, in solid form or in gel form.

The subject detergent compositions capable of foaming in aqueous media comprise at least one surfactant (S) selected from among anionic surfactants and nonionic surfactants, or mixtures thereof.

The amount of surfactant (S), expressed as dry solids, advantageously constitutes from 0.1% to 99% and preferably from 0.5% to 60% of the total weight of detergent composition capable of foaming.

When the detergent composition is a solid of soap bar type, the amount of surfactant (S), expressed as dry solids, advantageously constitutes up to 99% and preferably up to 95% of the total weight of detergent composition capable of foaming; this amount usually is at least 50% of the total weight of detergent composition capable of foaming. The solids of soap bar type may also contain water and/or a water-compatible solvent, in an amount that may be up to 20% of the weight of said solids.

The term “total weight of detergent composition” means that weight of all of the composition including, along with the surfactant (S) and the aliphatic alcohol (AA), the other optional constituents (water, solvents and other additives).

The expression “detergent composition capable of foaming in aqueous medium” is to be considered in the broad sense herein. It may be, for example:

a liquid composition comprising water (or a water/water-compatible solvent mixture), forming a foam on the surface to be treated by spraying using apparatus equipped with a nozzle (spray);

a liquid composition comprising water (or a water/water-compatible solvent mixture), forming a foam by shear obtained by manual or vortex mixing;

a solid, gel or aqueous or non-aqueous liquid composition forming a foam after dilution in water or with water and shear (rubbing, manual mechanical, or vortex mixing).

Examples of anionic surfactants that are representative, in particular, include:

alkylester sulfonates of formula R—CH(SO₃M)-COOR′ in which R is a C₈-C₂₀ and preferably C₁₀-C₁₆ alkyl radical, R′ is a C₁-C₆ and preferably C₁-C₃ alkyl radical and M is an alkali metal cation (sodium, potassium or lithium), substituted or unsubstituted ammonium (methylammonium, dimethylammonium, trimethyl ammonium, tetramethyl ammonium, dimethylpiperidinium, etc.) or an alkanolamine derivative (monoethanolamine, diethanolamine, triethanolamine, etc.). Exemplary most particularly are the methyl ester sulfonates in which the radical R is of C₁₄-C₁₆;

α-olefin sulfonates having from 12 to 16 carbon atoms;

alkyl sulfates of formula ROSO₃M, in which R is a C₅-C₂₄ and preferably C₁₀-C₁₈ alkyl or hydroxyalkyl radical, M representing a hydrogen atom or a cation of the same definition as above, and also ethoxylenated (OE) and/or propoxylenated (OP) derivatives thereof, containing on average from 0.5 to 30 and preferably from 0.5 to 10 GE and/or GP units;

alkylamide sulfates of formula RCONHR′OSO₃M, in which R is a C₂-C₂₂ and preferably C₆-C₂₀ alkyl radical, R′ is a C₂-C₃ alkyl radical, M representing a hydrogen atom or a cation of the same definition as above, and also the ethoxylenated (GE) and/or propoxylenated (GP) derivatives thereof, containing on average from 0.5 to 60 OE and/or OP units;

saturated or unsaturated C₈-C₂₄ and preferably C₁₄-C₂₀ fatty acid salts, C₉-C₂₀ alkylbenzenesulfonates, primary or secondary C₈-C₂₂ alkylsulfonates, alkylglycerol sulfonates, the sulfonated polycarboxylic acids described in GB-A-1,082,179, paraffin sulfonates, N-acyl N-alkyltaurates, alkyl phosphates, isethionates, alkylsuccinamates, alkylsulfosuccinates, sulfosuccinate-monoesters or diesters, N-acyl sarcosinates, alkylglycoside sulfates or polyethoxycarboxylates, the cation being an alkali metal (sodium, potassium or lithium), a substituted or unsubstituted ammonium residue (methylammonium dimethylammonium, trimethylammonium, tetramethylammonium, dimethylpiperidinium, etc.) or an alkanolamine derivative (monoethanolamine, -diethanolamine, triethanolamine, etc.);

alkyl or alkylaryl phosphate esters, for example Rhodafac RA600, Rhodafac PA15 or Rhodafac PA23 marketed by Rhodia.

The amount, expressed as dry solids, of anionic surfactant (when it is present) advantageously ranges from 0.5 to −90 parts, preferably from 5 to 60 parts and more particularly from 10 to 30 parts by weight per 100 parts by total weight of detergent composition.

Among the nonionic surfactants that are exemplary are alkylene oxide condensates, especially of ethylene oxide with alcohols, polyols or alkylphenols; fatty acid esters; fatty acid amides; fatty amines; amine oxides; sugar derivatives such as alkylpolyglycosides or fatty acid esters of sugars, especially sucrose monopalmitate; long-chain tertiary phosphine oxides; dialkyl sulfoxides; sequence copolymers of polyoxyethylene and of polyoxypropylene; polyalkoxylated sorbitan esters; fatty esters of sorbitan, poly(ethylene oxides) and fatty acid amides modified so as to impart to them a hydrophobic nature (for example fatty acid monoethanolamides and diethanolamides having from 10 to 18 carbon atoms).

Most particularly exemplary are:

polyoxyalkylenated (polyethoxyethylenated, polyoxypropylenated or polyoxybutylenated) alkylphenols, the alkyl substituent of which is of C₆₋₁₂ and contains from 5 to 25 oxyalkylene units; examples include Triton X-45, X-114, X-100 or X-102 marketed by Rohm & Hass Co.;

glucosamides, glucamides and glycerolamides;

polyoxyalkylenated C₈-C₂₂ aliphatic alcohols having from 1 to 25 oxyalkylene (oxyethylene or oxypropylene) structural units. Examples include Tergitol 15-S-9 and Tergitol 24-L-6 NMW marketed by Union Carbide Corp., Neodol 45-9, Neodol 23-65, Neodol 45-7 and Neodol 45-4 marketed by Shell Chemical Co., Rhodasurf 1D060, Rhodasurf LA90 and Rhodasurf IT070 marketed by Rhodia;

amine oxides such as C₁₀-C₁₈ alkyl dimethylamine oxides or C₈-C₂₂ alkoxy ethyldihydroxyethylamine oxides;

the alkylpolyglycosides described in U.S. Pat. No. 4,565,647;

optionally polyhydroxylated C₈-C₂₀ fatty acid amides,

ethoxylated fatty acids;

ethoxylated amines.

When they are present, said nonionic surfactants advantageously represent from 0.1% to 20%, preferably from 0.1% to 15% and more particularly from 0.5% to 10% (as dry matter) of the total weight of said composition.

Along with the anionic and/or nonionic surfactant(s), one or more cationic, amphoteric or zwitterionic surfactants may also be present in the detergent composition.

Cationic surfactants are especially alkylammonium salts of formula:
R¹R²R³R⁴N⁺X⁻
in which

X⁻ is a halogen ion, CH₃SO₄⁻ or C₂H₅SO₄⁻;

R¹ and R², which may be identical or different, are each a C₁-C₂₀ alkyl radical or an aryl or benzyl radical;

R³ and R⁴, which may be identical or different, are each a C₁-C₂₀ alkyl radical, an aryl or benzyl radical or an ethylene oxide and/or propylene oxide condensate (CH₂CH₂O)ₓ—(CH₂CHCH₃O)y-H, in which x and y range from 0 to 30 and are never both zero, for example cetyltrimethylammonium bromide, or Rhodaquat® TFR marketed by Rhodia.

When they are present, said cationic surfactants advantageously represent up to 10% and preferably from 1% to 5% as dry solids of the total weight of said composition.

Examples of zwitterionic surfactants include quaternary aliphatic ammonium derivatives, especially 3-(N,N-dimethyl-N-hexadecylammonio)propane 1-sulfonate and 3-(N,N-dimethyl-N-hexadecylammonio)-2-hydroxy-propane 1-sulfonate.

Examples of amphoteric surfactants include betaines, sulfobetaines and fatty acid and imidazole carboxylates and sulfonates.

The following surfactants are preferred:

alkyldimethylbetaines, alkylamidopropyldimethylbetaines, alkyldimethylsulfobetaines or alkylamidopropyldimethylsulfobetaines, for example Mirataine CBS marketed by Rhodia, and the products of condensation of fatty acids and of protein hydrolyzates;

alkylamphoacetates or alkylamphodiacetates which the alkyl group contains from 6 to 20 carbon atoms;

amphoteric derivatives of alkylpolyamines, for example Amphionic XL® marketed by Rhodia, and Ampholac 7C/X® and Ampholac 7C/X® marketed by Berol Nobel.

The aliphatic alcohols (AA) according to the invention are C₈-C₂₂, preferably C₁₂-C₁₈ and particularly C₁₂-C₁₆ aliphatic alcohols, or mixtures thereof.

They are preferentially monoalcohols, most particularly linear alcohols.

Especially exemplary are 1-dodecanol (lauryl alcohol), 1-tetradecanol (myristyl alcohol), 1-hexadecanol (cetyl alcohol) and 1-octadecanol (stearyl alcohol), most particularly 1-dodecanol alcohol) and 1-tetradecanol (myristyl alcohol).

According to the invention, said aliphatic alcohol (AA) is advantageously employed in an amount that may range from 0.01 to 100, preferably from 0.1 to 20 and most particularly from 1 to 10 parts by weight per 100 parts by weight of surfactant (S) (expressed as dry solids) present in the detergent composition.

Preferentially, the length of the aliphatic chain of the aliphatic alcohol (AA) is the same or very close to the length of the lipophilic moiety of the surfactant (S).

According to the invention, said aliphatic alcohol (AA) is employed especially as an agent for improving the appearance and rheology of the foam formed by using the detergent composition in aqueous medium under the usual conditions for the use of said composition.

According to the invention, the term “appearance” of the foam primarily means its whiteness, i.e., its opacity.

The detergent compositions comprising said aliphatic alcohol (AA) for cleaning or maintaining textiles or hard surfaces may have a multitude of applications, especially

maintenance of toilet bowls; said compositions may be in the form of blocks, tablets, gels or fragrancing and/or bactericidal liquids to be attached to the inner wall of the toilet bowl, or to be introduced into the toilet bowl or the cistern;

maintenance of bathroom or kitchen surfaces;

washing of kitchenware by hand; the composition is preferably in the form of a concentrated liquid or a gel;

washing articles made of textile fibers by hand or in a semiautomatic machine; the composition is preferably in the form of a concentrated liquid, a gel or a bar;

washing motor vehicles, by hand or in a station.

The formation of foam from the detergent composition comprising said aliphatic alcohol (AA), under shear conditions representative of the above applications, may be simulated by means of the test described below. The whiteness of the foam formed may be evaluated by image analysis.

Foaming Method:

An aqueous solution of detergent composition to be tested is prepared, comprising said surfactant (S) and said aliphatic alcohol (AA) and the other optional additives, the amount of detergent composition being such that the surfactant (S) concentration of said aqueous solution is 0.5 g/liter of aqueous solution.

30 ml of this solution are introduced into a 100 ml graduated cylinder (length 250 mm/28 mm inside diameter); the closed cylinder is turned upside down 20 times manually. A foam is obtained.

Image Analysis:

Digital photographs of the foam thus generated are taken in front of a black background, at regular intervals (for example every 10 minutes); the photographs are then converted into 256 levels of gray (gray scale from 0 to 255, 0 corresponding to black and 255 to white).

The number of pixels corresponding to each level of gray are counted. A histogram is thus obtained, the mean value of which is from 0 to 255.

The mean value obtained for an empty cylinder in front of the same black background is subtracted from the value obtained for a foam, so as to obtain a value of 0 in the absence of foam.

This value is normalized to 100 using a reference foam freshly generated (time zero) with an aqueous solution of detergent composition free of aliphatic alcohol (AA), the amount of detergent composition free of aliphatic alcohol (AA) being such that the surfactant (S) concentration of said aqueous solution is 0.5 g/liter of aqueous solution. A “whiteness” value of from 0 to 100 is thus obtained as a function of the change in the appearance of the reference foam over time.

Evaluation:

The foam corresponding to the detergent composition to be tested is generated and analyzed as above (cylinder turned upside down 20 times, digital photographs taken at regular intervals and production of a histogram).

A value of greater than 100 may be obtained if a test foam is whiter than the reference foam.

Under the conditions of this test, a “whiteness” value of less than 60 is considered as degraded (the foam gradually becomes transparent).

It was also found that the presence of the alkanol (AA) gives the foam formed under the usual conditions of use a creamy appearance, due to the conservation of the small bubbles.

Preferably, the detergent composition also comprises water and/or at least one water-compatible solvent.

The term “water-compatible solvent” means any solvent which, when mixed with water, forms a single transparent phase at room temperature.

Water and/or the solvent may constitute up to 99.5% of the total weight of said composition; the minimum amount of water and/or water-compatible solvent is usually 1%. When it is a matter of a water/solvent mixture, said solvent may constitute up to 80% of the weight of said mixture.

Said solvent is preferably selected from among C₂-C₈ aliphatic monoalcohols or polyalcohols, and ethers thereof.

Examples of solvents that are especially representative include ethanol, propanol, isopropanol, butanol, 2-butoxyethanol, diethylene glycol, 1-butoxyethanol-2-propanol and diethylene monobutyl ether.

Said composition, especially when it is a concentrated liquid composition, may also comprise at least one polymer to control the viscosity and/or stability of foams, for example polyacrylic acids or water-soluble salts thereof with a weight-average molecular weight of from 1,000 to 5,000,000 g/mol, block copolymers of ethylene oxide-propylene oxide with a weight-average molecular weight of up to 30,000 g/mol, polyethylene glycols with a molecular weight of at least 400 g/mol, and biopolymers with a molecular weight of at least 10,000 g/mol; when it is present, said polymer may constitute from 0.01% to 10% of the weight, as dry solids, of the concentrated liquid composition.

The term “concentrated composition” means any composition that may be diluted during use.

As examples of polymers capable of controlling the viscosity and/or stability of foams, representative are:

polyacrylic acids or salts thereof, for example the Carbopols from B.F. Goodrich, especially Carbopol 941, Carbopol 801, Carbopol 907, Carbopol 910, Carbopol 934 and Carbopol 940;
block copolymers of ethylene oxide-propylene oxide, for example the Antarox products from Rhodia, especially Antarox F-88;
biopolymers, for example guar gum, gum arabic, xanthan gum, rheozan gum, welan gum, carrageenans, and cellulose or guar derivatives (carboxymethylcellulose, hydroxyethylcellulose, hydroxypropyl guar, carboxymethyl guar or carboxymethylhydroxypropyl guar).

Bleaching agents, detergence adjuvants (builders) hydrotropic agents, hydrating agents, fragrances, biocides, preservatives and other common additives may also be present, depending on the intended use of the detergent composition.

As regards compositions for maintaining toilet bowls, along with thickeners of gum type (especially a xanthan gum introduced to a concentration of from 0.1% to 3%) especially exemplary are:

optionally, acidic cleaning agents such as mineral acids (phosphoric acid, sulfamic acid, hydrochloric acid, hydrofluoric acid, sulfuric acid, nitric acid or chromic acid) or organic acids (acetic acid, hydroxyacetic acid, adipic acid, citric acid, formic acid, fumaric acid, gluconic acid, glutaric acid, glycolic acid, malic acid, maleic acid, lactic acid, malonic acid, oxalic acid, succinic acid or tartaric acid) and acid salts (sodium bisulfate);

and also one or more of the following minor ingredients: a preservative for preventing the growth of microorganisms in the product, a colorant, a fragrance and/or an abrasive agent.

As regards compositions for maintaining kitchen or bathroom surfaces, especially exemplary are organic or mineral detergence adjuvants (builders) (sodium carbonate, zeolites, sodium silicates, mineral phosphates, polyacrylates or citrates), pH regulators, colorants, optical brighteners, soiling suspension agents, detersive enzymes, compatible bleaching agents, agents for regulating the formation of gel, freezing-thawing stabilizers, insect repellents, hydrotropic agents, and opacifiers or pearlescent agents.

As regards compositions for washing kitchenware by hand, especially exemplary are:

synthetic cationic polymers, for example Mirapol A550® and Mirapol A15® marketed by Rhodia, and Merquat 550® marketed by Calgon;

hydrotropic agents, for example C₂-C8 short alcohols, in particular ethanol, diols and glycols, for example diethylene glycol or dipropylene glycol,

moisturizers or humectants for the skin, for example glycerol, urea or skin-protecting agents, for example proteins or protein hydrolyzates, and cationic polymers, for example cationic guar derivatives (Jaguar C13S®, Jaguar C162® and Hicare 1000® marketed by Rhodia).

As regards compositions for washing laundry by hand or in a semiautomatic machine, especially exemplary are organic or mineral detergence adjuvants (builders) (sodium carbonate, zeolites, sodium silicates, mineral phosphates, polyacrylates or citrates), anti-redeposition agents, anti-soiling agents, color-transfer blockers and nonionic softeners.

As regards compositions for cleaning motor vehicle bodywork, especially exemplary are organic or mineral detergence adjuvants (builders), hydrotropic agents, fillers, pH regulators and copolymers for modifying the surface properties.

The present invention is most particularly advantageous for washing kitchenware or textile fiber articles by hand, and also for cleaning toilet bowls.

As regards detergent compositions intended to be diluted at the time of use, they may be diluted by 10 to 50,000 times their volume depending on their intended use. The surfactant concentration thereof, after dilution, may generally be from 0.0001% to 10%, preferably from 0.001% to 5% and most particularly from 0.005% to 2%.

Method for Evaluating the Whiteness of a Foam:

Calibration:

A reference aqueous solution comprising 0.5 g/l of sodium lauryl ether sulfate is prepared.

30 ml of this solution are introduced into a 100 ml graduated cylinder (length 250 mm/inside diameter 28 mm); the closed cylinder is turned upside down 20 times manually.

Digital photographs of the foam thus generated (reference foam) are then taken in front of a black background, at regular intervals; the photographs are then converted into 256 levels of gray (gray scale from 0 to 255).

The number of pixels corresponding to each level of gray are counted. A histogram is thus obtained, the mean value of which is from 0 and 255.

The mean value obtained for an empty cylinder in front of the same black background is subtracted from the value obtained for a foam, so as to obtain a value of 0 in the absence of foam.

This value is normalized to 100 for the freshly generated (time zero) reference foam.

A “whiteness” value of from 0 and 100 is thus obtained as a function of the change in the appearance of the reference foam over time.

Evaluation:

The foam corresponding to the detergent composition to be tested is generated and analyzed as above (cylinder turned upside down 20 times, digital photographs taken at regular intervals and production of a histogram).

A value of greater than 100 may be obtained if a test foam is whiter than the reference foam.

Under the conditions of this test, a “whiteness” value of less than 60 is considered as degraded (the foam gradually becomes transparent).

In order to further illustrate the present invention and the advantages thereof, the following specific examples are given, it being understood that same are intended only as illustrative and in nowise limitative. In said examples to follow, all parts and percentages are given by weight, unless otherwise indicated.

### EXAMPLE 1

### Whiteness of the Reference Foam Generated with an Aqueous Solution of Reference Surfactant

The change in whiteness of the reference foam generated with the reference solution as a function of time is reported in the following table:

| Time in minutes | Whiteness |
|---|---|
| 0 | 100 |
| 10 | 75 |
| 20 | 73 |
| 30 | 61 |
| 40 | 58 |
| 50 | 52 |
| 60 | 62 |
| 80 | 44 |
| 150 | 43 |
| 1080 | 17 |

The witness of the foam is degraded after 30-40 minutes.

### EXAMPLE 2

### Whiteness of a Foam Generated According to the Invention

An aqueous solution comprising 0.5 g/l of sodium lauryl ether sulfate is prepared.

0.05 g/l of a solution of myristyl alcohol at 20% by weight in ethanol, which corresponds to 2 parts by weight of myristyl alcohol per 100 parts by weight of sodium lauryl ether sulfate, is added thereto.

30 ml of this solution are introduced into a 100 ml graduated cylinder; the closed cylinder is turned upside down 20 times manually.

The change in whiteness of the generated foam as a function of time is reported in the following table:

| Time in minutes | Whiteness |
|---|---|
| 0 | 105 |
| 10 | 91 |
| 20 | 91 |
| 30 | 79 |
| 40 | 78 |
| 50 | 72 |
| 60 | 70 |
| 80 | 69 |
| 150 | 63 |
| 1080 | 48 |

It is found that the starting whiteness value is slightly improved by the presence of myristyl alcohol and that the degradation in whiteness as a function of time is markedly lower and slower (by at least 5-fold).

Each patent, patent application, publication, text and literature article/report cited or indicated herein is hereby expressly incorporated by reference.

While the invention has been described in terms of various specific and preferred embodiments, the skilled artisan will appreciate that various modifications, substitutions, omissions, and changes may be made without departing from the spirit thereof. Accordingly, it is intended that the scope of the present invention be limited solely by the scope of the following claims, including equivalents thereof.

What is claimed is:

1. A detergent composition that foams into a foam having improved rheology and appearance (whiteness) and is useful for cleaning or maintaining textiles or hard surfaces, comprising at least one surfactant (S) selected from the group consisting of anionic and nonionic surfactants and mixtures thereof, and at least one C₈-C₂₂ aliphatic alcohol (AA).

2. The detergent composition as defined by claim 1, comprising at least one C₁₂-C₁₈ aliphatic alcohol (AA).

3. The detergent composition as defined by claim 1, comprising at least one C₁₂-C₁₆ aliphatic alcohol (AA).

4. The detergent composition as defined by claim 1, comprising from 0.1% to 99% by weight of said at least one surfactant (S).

5. The detergent composition as defined by claim 1, comprising from 0.5% to 60% by weight of said at least one surfactant (S).

6. The detergent composition as defined by claim 1, comprising from 0.5 to 90 parts by weight of at least one anionic surfactant, expressed as dry solids, per 100 parts by weight thereof.

7. The detergent composition as defined by claim 1, comprising from 0.5 to 60 parts by weight of at least one anionic surfactant, expressed as dry solids, per 100 parts by weight thereof.

8. The detergent composition as defined by claim 1, comprising from 10 to 30 parts by weight of at least one anionic surfactant, expressed as dry solids, per 100 parts by weight thereof.

9. The detergent composition as defined by claim 1, comprising from 0.1% to 20% by weight of at least one nonionic surfactant, expressed as dry solids.

10. The detergent composition as defined by claim 1, comprising from 0.1% to 15% by weight of at least one nonionic surfactant, expressed as dry solids.

11. The detergent composition as defined by claim 1, comprising from 0.5% to 10% by weight of at least one nonionic surfactant, expressed as dry solids.

12. The detergent composition as defined by claim 1, comprising at least one linear monoalcohol (AA).

13. The detergent composition as defined by claim 1, said at least one aliphatic alcohol (AA) being selected from the group consisting of 1-dodecanol (lauryl alcohol), 1-tetradecanol (myristyl alcohol), 1-hexadecanol (cetyl alcohol) and 1-octadecanol (stearyl alcohol).

14. The detergent composition as defined by claim 1, the length of the aliphatic chain of said at least one aliphatic alcohol (AA) being about the same as the length of the lipophilic moiety of said at least one surfactant (S).

15. The detergent composition as defined by claim 1, comprising from 0.01% to 100 parts by weight of said at least one aliphatic alcohol (AA) per 100 parts by weight of said at least one surfactant (S), expressed as dry solids.

16. The detergent composition as defined by claim 1, further comprising water and/or at least one water-compatible solvent.

17. The detergent composition as defined by claim 16, comprising at least one water-compatible solvent selected from the group consisting of C₂-C₈ aliphatic monoalcohols or polyalcohols and ethers thereof.

18. A method for maintaining toilet bowls, maintaining bathroom or kitchen surfaces, washing kitchenware, washing articles made of textile fibers or washing motor vehicles, comprising washing/treating same with an aqueous and/or water-compatible solvent foam of the detergent composition as defined by claim 1.

19. A foam having enhanced appearance and rheology, generated from the detergent composition as defined by claim 1 formulated into an aqueous and/or water-compatible solvent medium therefor.

20. A foam having enhanced whiteness, generated from the detergent composition as defined by claim 1 formulated into an aqueous and/or water-compatible solvent medium therefor.

21. The detergent composition as defined by claim 1, further comprising at least one cationic, amphoteric and/or zwitterionic surfactant.

22. The foam as defined by claim 19, comprising at least one polymer for controlling the viscosity and/or stability thereof.

23. The detergent composition as defined by claim 1, further comprising at least one bleaching agent, detergent builder, hydrotropic agent, colorant, abrasive, hydrating agent, fragrance, thickener, acid, biocide and/or preservative.

24. The detergent composition as defined by claim 1, formulated as a solid.

25. The detergent composition as defined by claim 1, formulated as a gel.
